(19) United States
(12) Patent Application Publication
(10) Pub. No.: US 2026/0025204 A1
(43) Pub. Date: Jan. 22, 2026

(54) OPTICAL WIRELESS COMMUNICATION SYSTEM, OPTICAL WIRELESS COMMUNICATION APPARATUS AND OPTICAL WIRELESS COMMUNICATION METHOD

(71) Applicant: NIPPON TELEGRAPH AND TELEPHONE CORPORATION, Tokyo (JP)

(72) Inventors: Tatsuhiko IWAKUNI, Musashino-shi, Tokyo (JP); Takuto ARAI, Musashino-shi, Tokyo (JP); Toshiro NAKAHIRA, Musashino-shi, Tokyo (JP); Ryota SHIINA, Musashino-shi, Tokyo (JP)

(73) Assignee: NIPPON TELEGRAPH AND TELEPHONE CORPORATION, Tokyo (JP)

(21) Appl. No.: 18/869,257

(22) PCT Filed: May 30, 2022
(86) PCT No.: PCT/JP2022/021876

§ 371 Date: Nov. 25, 2024

(51) Int. Cl. H04B 10/114; H04B 10/40; H04B 10/61

(52) U.S. Cl. CPC H04B 10/114; H04B 10/40; H04B 10/6151

(57) ABSTRACT

In an optical wireless communication system including a first optical wireless communication device and a second optical wireless communication device, the first optical wireless communication device includes a transmission unit that transmits an optical signal to the second optical wireless communication device via a first polarizing filter, and the second optical wireless communication device includes a reception unit that receives the optical signal via a second polarizing filter, a measurement unit that measures a signal intensity of the optical signal, and a control unit that changes a direction of the second polarizing filter or the first polarizing filter to cause the signal intensity to be higher.

### TECHNICAL FIELD

The present invention relates to an optical wireless communication system, an optical wireless communication device, an optical wireless communication method.

### BACKGROUND ART

With depletion of radio frequency resources, an optical wireless communication system has been studied that implements wireless communication by a method different from conventional wireless communication using radio waves. The optical wireless communication system is a communication system that performs wireless communication using electromagnetic waves (light) having a wavelength from infrared light to visible light. According to the optical wireless communication system, it is possible to implement wireless communication that does not interfere with conventional wireless communication using a predetermined frequency band. In addition, the optical wireless communication system does not transmit light through a shield such as a wall of a building, for example, and thus has interception resistance, and has attracted attention also from a viewpoint of high security (for example, see Non Patent Literature 1).

Hereinafter, a description will be given of a configuration of a general optical wireless communication system in a case where visible light is used for transmission of a downlink signal. FIG. 11 is a diagram illustrating an example of the configuration of the general optical wireless communication system. An optical wireless communication system 8 illustrated in FIG. 11 includes an optical wireless communication device 810 and an optical wireless communication device 820. The optical wireless communication device 810 is, for example, communication equipment installed on an indoor ceiling or the like, and functions as a wireless base station that accommodates the optical wireless communication device 820. In addition, the optical wireless communication device 820 is, for example, a small terminal device, and communicates with the optical wireless communication device 810.

As illustrated in FIG. 11, the optical wireless communication device 810 includes a light source 811, an infrared light receiving unit 812, and an optical signal processing unit 813. The light source 811 includes, for example, a light emitting diode (LED) and sends out visible light VL. Note that the light source 811 may be provided in a general lighting fixture or the like. The light source 811 is connected to the optical signal processing unit 813. The optical signal processing unit 813 can control the light source 811 to change a lighting cycle, a lighting intensity, and the like of the visible light VL sent out from the light source 811. The optical signal processing unit 813 converts desired information to be transmitted to the optical wireless communication device 820 into an optical signal represented by a change in the visible light VL. As a result, the optical signal (downlink signal) using the visible light VL is transmitted from the optical wireless communication device 810 to the optical wireless communication device 820. Note that the optical signal processing unit 813 may be connected to a higher-level communication network, for example, the Internet, an intranet, or the like.

As illustrated in FIG. 11, the optical wireless communication device 820 includes a visible light receiving unit 821 and an infrared light transmission unit 822. The visible light receiving unit 821 receives the visible light VL sent out from the light source 811. The visible light receiving unit 821 reads the optical signal (downlink signal) included in the visible light VL. The optical wireless communication device 820 performs various types of processing such as reception processing and data conversion on the optical signal read by the visible light receiving unit 821. In addition, infrared light is used for an optical signal (uplink signal) transmitted from the optical wireless communication device 820 to the optical wireless communication device 810. The infrared light transmission unit 822 transmits an optical signal using infrared light to the optical wireless communication device 810.

The infrared light sent out from the infrared light transmission unit 822 is received by the infrared light receiving unit 812 of the optical wireless communication device 810. The infrared light receiving unit 812 reads the optical signal (uplink signal) included in the infrared light. The infrared light receiving unit 812 is connected to the optical signal processing unit 813. The optical signal processing unit 813 performs various types of processing such as reception processing and data conversion on the optical signal read by the infrared light receiving unit 812. Note that the optical signal processing unit 813 may transfer the optical signal subjected to the various types of processing to a higher-level communication network. In this way, the general optical wireless communication system is implemented that uses visible light and infrared light.

Note that the optical wireless communication system 8 illustrated in FIG. 11 has a system configuration assuming that a downlink signal is transmitted by using existing lighting equipment such as LED lighting installed indoors, for example, but may have a configuration in which infrared light is also used for transmission of the downlink signal. FIG. 12 is a diagram illustrating an example of a configuration of an optical wireless communication system using infrared light for both transmission of an uplink signal and transmission of a downlink signal. An optical wireless communication system 9 illustrated in FIG. 12 includes an optical wireless communication device 910 and an optical wireless communication device 920. The optical wireless communication device 910 includes an infrared light transmission unit 911, an infrared light receiving unit 912, and an optical signal processing unit 913. The infrared light transmission unit 911 is connected to the optical signal processing unit 913. The optical signal processing unit 913 can control the infrared light transmission unit 911 to blink infrared light sent out from the infrared light transmission unit 911. The optical signal processing unit 913 converts desired information to be transmitted to the optical wireless communication device 920 into an optical signal represented by, for example, on and off of infrared light. As a result, the optical signal (downlink signal) using infrared light is transmitted from the optical wireless communication device 910 to the optical wireless communication device 820.

As illustrated in FIG. 12, the optical wireless communication device 920 includes an infrared light receiving unit 921 and an infrared light transmission unit 922. The infrared light receiving unit 921 receives the infrared light sent out from the infrared light transmission unit 911. The infrared light receiving unit 921 reads the optical signal (downlink signal) included in the infrared light. The optical wireless communication device 920 performs various types of processing such as reception processing and data conversion on the optical signal read by the infrared light receiving unit 921. In addition, as an optical signal (uplink signal) transmitted from the optical wireless communication device 920 to the optical wireless communication device 910, infrared light is used similarly to the optical wireless communication system 8 illustrated in FIG. 11 described above. Configurations of the infrared light transmission unit 922 and the infrared light receiving unit 912 are similar to configurations of the infrared light transmission unit 822 and the infrared light receiving unit 812 illustrated in FIG. 11 described above.

The infrared light receiving unit 912 of the optical wireless communication device 910 is connected to the optical signal processing unit 913. The optical signal processing unit 913 performs various types of processing such as reception processing and data conversion on the optical signal read by the infrared light receiving unit 912. In this way, the general optical wireless communication system is implemented that uses infrared light for both the transmission of the uplink signal and the transmission of the downlink signal.

Note that the optical wireless communication system 8 illustrated in FIG. 11 has a configuration in which wireless communication is performed between the optical wireless communication device 810 that is a wireless base station and the optical wireless communication device 820 that is a wireless communication terminal, and the optical wireless communication system 9 illustrated in FIG. 12 has a configuration in which wireless communication is performed between the optical wireless communication device 910 that is a wireless base station and the optical wireless communication device 920 that is a wireless communication terminal; however, the systems are not limited to have such configurations. For example, the communication system may be a communication system for performing wireless communication using visible light, infrared light, or the like between a plurality of optical wireless communication devices having the same configuration, such as a plurality of wireless relay stations in relay wireless. As described above, the optical wireless communication system can have any system configuration according to an object.

### CITATION LIST

### Non Patent Literature

Non Patent Literature 1: S. Wu, H. Wang and C. Youn, “Visible Light Communications for 5G Wireless Networking Systems: From Fixed to Mobile Communications,” IEEE Network, vol. 28, no. 6, pp. 41-45, November-December 2014 Non Patent Literature 2: Isao Yoda, “Optics for Light Polarizers and Their Applications” Journal of the Illuminating Engineering Institute of Japan, Vol. 42, No. 1, pp. 7-14, 1958

### SUMMARY OF INVENTION

### Technical Problem

A transmission frequency (equivalent to a transmission wavelength) of signal light in the optical wireless communication system is defined by an element used for a light source such as an LED. Here, in a case where a plurality of optical signals is simultaneously transmitted by using a plurality of light sources of the same type installed close to each other, interference occurs between the optical signals, and transmission characteristics may deteriorate.

FIG. 13 is a diagram illustrating an example of a configuration of an optical wireless communication system that simultaneously transmits a plurality of optical signals by using a plurality of light sources of the same type. An optical wireless communication system 8′ illustrated in FIG. 13 has a configuration in which two sets of the optical wireless communication device 810 and the optical wireless communication device 820 of the optical wireless communication system 8 illustrated in FIG. 11 are installed close to each other. As illustrated in FIG. 13, an optical wireless communication device 810-1 and an optical wireless communication device 820-1 are a set of optical wireless communication devices that communicate with each other, and an optical wireless communication device 810-2 and an optical wireless communication device 820-2 are a set of optical wireless communication devices that communicate with each other.

In the optical wireless communication system 8′ illustrated in FIG. 13 in which a plurality of the light sources 811 of the same type is installed close to each other, downlink signals are respectively transmitted from the plurality of light sources 811 to a plurality of the optical wireless communication devices 820. In such a case, there has been a problem that interference occurs between two downlink signals, and transmission characteristics may deteriorate. In addition, there has been a similar problem not only in transmission of downlink signals but also in transmission of uplink signals.

In view of the above circumstances, an object of the present invention is to provide a technology capable of performing optical wireless communication without causing interference between optical signals even in a case where the optical signals are respectively transmitted by using a plurality of light sources of the same type.

### Solution to Problem

An aspect of the present invention is an optical wireless communication system including a plurality of first optical wireless communication devices, and a plurality of second optical wireless communication devices, the optical wireless communication system forming a communication link for each of combinations of the first optical wireless communication devices and the second optical wireless communication devices, in which the first optical wireless communication devices include a transmission unit that transmits an optical signal to the second optical wireless communication devices via a first polarizing filter, and the second optical wireless communication devices include: a reception unit that receives the optical signal via a second polarizing filter; a measurement unit that measures a signal intensity of the optical signal; and a control unit that changes a direction of the second polarizing filter or the first polarizing filter to cause the signal intensity to be higher.

In addition, an aspect of the present invention is an optical wireless communication system including a plurality of first optical wireless communication devices, and a plurality of second optical wireless communication devices, the optical wireless communication system forming a communication link for each of combinations of the first optical wireless communication devices and the second optical wireless communication devices, in which the first optical wireless communication devices include a transmission unit that transmits an optical signal including instruction information designating a direction of a second polarizing filter to the second optical wireless communication devices via a first polarizing filter, and the second optical wireless communication devices include: a reception unit that receives the optical signal via the second polarizing filter; an acquisition unit that acquires the instruction information from the optical signal; and a control unit that changes the direction of the second polarizing filter to cause the direction of the second polarizing filter to be the direction designated by the instruction information.

In addition, an aspect of the present invention is an optical wireless communication device including: a reception unit that receives, via a second polarizing filter, an optical signal transmitted from another optical wireless communication device via a first polarizing filter; a measurement unit that measures a signal intensity of the optical signal; and a control unit that changes a direction of the second polarizing filter or the first polarizing filter to cause the signal intensity to be higher.

In addition, an aspect of the present invention is an optical wireless communication device including: a reception unit that receives, via a second polarizing filter, an optical signal transmitted from another wireless communication device via a first polarizing filter, the optical signal including instruction information designating a direction of the second polarizing filter; an acquisition unit that acquires the instruction information from the optical signal; and a control unit that changes the direction of the second polarizing filter to cause the direction of the second polarizing filter to be the direction designated by the instruction information.

In addition, an aspect of the present invention is an optical wireless communication method by an optical wireless communication system including a plurality of first optical wireless communication devices, and a plurality of second optical wireless communication devices, the optical wireless communication system forming a communication link for each of combinations of the first optical wireless communication devices and the second optical wireless communication devices, the optical wireless communication method including: a transmission step in which the first optical wireless communication devices transmit an optical signal to the second optical wireless communication devices via a first polarizing filter; a reception step in which the second optical wireless communication devices receive the optical signal via a second polarizing filter; a measurement step in which the second optical wireless communication devices measure a signal intensity of the optical signal; and a control step in which the second optical wireless communication devices change a direction of the second polarizing filter or the first polarizing filter to cause the signal intensity to be higher.

In addition, an aspect of the present invention is an optical wireless communication method by an optical wireless communication system including a plurality of first optical wireless communication devices, and a plurality of second optical wireless communication devices, the optical wireless communication system forming a communication link for each of combinations of the first optical wireless communication devices and the second optical wireless communication devices, the optical wireless communication method including: a transmission step in which the first optical wireless communication devices transmit an optical signal including instruction information designating a direction of a second polarizing filter to the second optical wireless communication devices via a first polarizing filter; a reception step in which the second optical wireless communication devices receive the optical signal via the second polarizing filter; an acquisition step in which the second optical wireless communication devices acquire the instruction information from the optical signal; and a control step in which the second optical wireless communication devices change the direction of the second polarizing filter to cause the direction of the second polarizing filter to be the direction designated by the instruction information.

### Advantageous Effects of Invention

According to the present invention, even in a case where optical signals are respectively transmitted by using a plurality of light sources of the same type, optical wireless communication can be performed without causing interference between the optical signals.

### BRIEF DESCRIPTION OF DRAWINGS

FIG. 1 is a diagram illustrating a configuration of an optical wireless communication system 1 in a first embodiment of the present invention.

FIG. 2 is a schematic diagram illustrating a configuration of a polarizing filter 115 in the first embodiment of the present invention.

FIG. 3 is a diagram for explaining light shielding by the polarizing filter 115 and a polarizing filter 125 in the first embodiment of the present invention.

FIG. 4 is a diagram for explaining transmission of light by the polarizing filter 115 and the polarizing filter 125 in the first embodiment of the present invention.

FIG. 5 is a diagram for explaining a configuration of a rotation mechanism 127 of the polarizing filter 125 included in an optical wireless communication device 120 in the first embodiment of the present invention.

FIG. 6 is a diagram for explaining the configuration of the rotation mechanism 127 of the polarizing filter 125 included in the optical wireless communication device 120 in the first embodiment of the present invention.

FIG. 7 is a block diagram illustrating a configuration of the optical wireless communication device 120 in the first embodiment of the present invention.

FIG. 8 is a flowchart illustrating operation of the optical wireless communication device 120 in the first embodiment of the present invention.

FIG. 9 is a block diagram illustrating a configuration of an optical wireless communication device 120a in a second embodiment of the present invention.

FIG. 10 is a flowchart illustrating operation of the optical wireless communication device 120a in the second embodiment of the present invention.

FIG. 11 is a diagram illustrating an example of a configuration of a general optical wireless communication system.

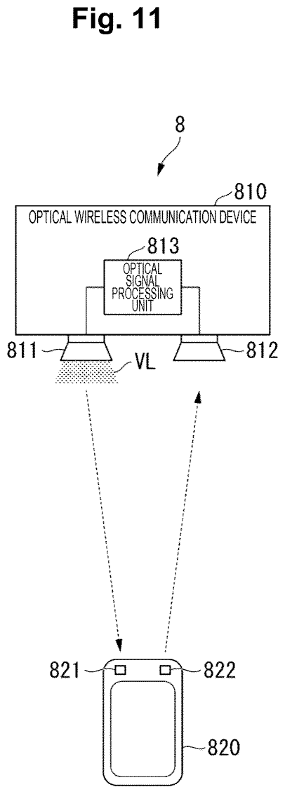

FIG. 12 is a diagram illustrating an example of a configuration of an optical wireless communication system using infrared light for both transmission of an uplink signal and transmission of a downlink signal.

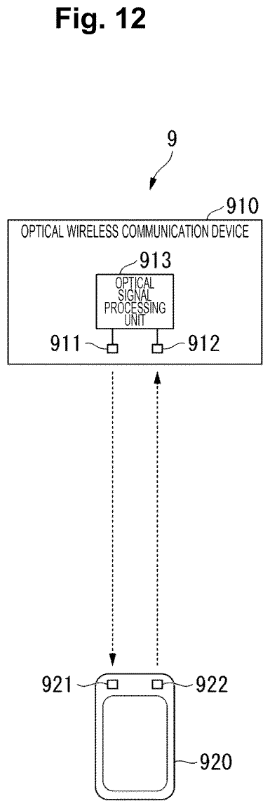

FIG. 13 is a diagram illustrating an example of a configuration of an optical wireless communication system that simultaneously transmits a plurality of optical signals by using a plurality of light sources of the same type.

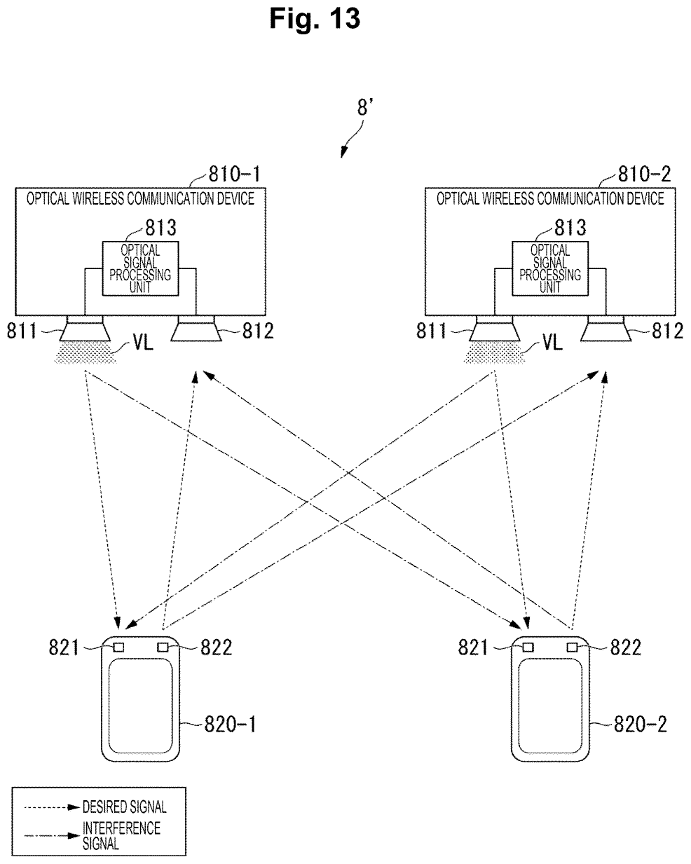

### DESCRIPTION OF EMBODIMENTS

Hereinafter, an optical wireless communication system, an optical wireless communication device, and an optical wireless communication method of the present invention will be described with reference to the drawings. The present invention relates to an optical wireless communication system, an optical wireless communication device, and an optical wireless communication method that implement optical wireless communication using visible light, infrared light, or the like. Note that embodiments described below each are merely one form, and embodiments to which the present invention can be applied are not limited to the embodiments described below.

### First Embodiment

Hereinafter, a first embodiment of the present invention will be described.

### Configuration of Optical Wireless Communication System

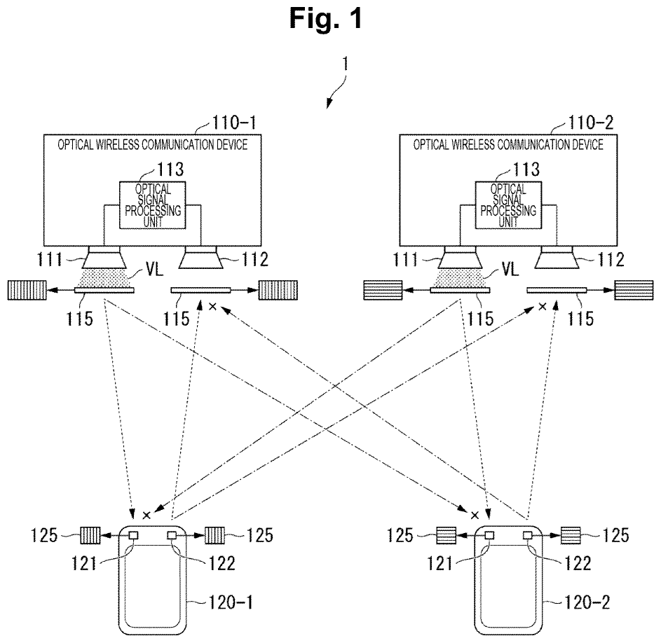

Hereinafter, a description will be given of a configuration of an optical wireless communication system 1 in the first embodiment. FIG. 1 is a diagram illustrating a configuration of the optical wireless communication system 1 in the first embodiment of the present invention. As illustrated in FIG. 1, the optical wireless communication system 1 includes an optical wireless communication device 110-1, an optical wireless communication device 110-2, an optical wireless communication device 120-1, and an optical wireless communication device 120-2.

Note that, in the following description, in a case where it is not necessary to distinguish the optical wireless communication device 110-1 and the optical wireless communication device 110-2 from each other for explanation, they may be simply referred to as “optical wireless communication device 110”. In addition, in the following description, in a case where it is not necessary to distinguish the optical wireless communication device 120-1 and the optical wireless communication device 120-2 from each other for explanation, they may be simply referred to as “optical wireless communication devices 120”.

The optical wireless communication device 110-1 is, for example, communication equipment installed on an indoor ceiling or the like, and functions as a wireless base station that accommodates the optical wireless communication device 120-1. Similarly, the optical wireless communication device 110-2 is, for example, communication equipment installed on an indoor ceiling or the like, and functions as a wireless base station that accommodates the optical wireless communication device 120-2.

The optical wireless communication device 120-1 is, for example, a small terminal device, and communicates with the optical wireless communication device 110-1. Similarly, the optical wireless communication device 120-2 is, for example, a small terminal device, and communicates with the optical wireless communication device 110-2.

As illustrated in FIG. 1, the optical wireless communication device 110-1 includes a light source 111, an infrared light receiving unit 112, an optical signal processing unit 113, and two polarizing filters 115. The light source 111 includes, for example, an LED and sends out visible light VL. Note that the light source 111 may be provided in a general lighting fixture or the like. The light source 111 is connected to the optical signal processing unit 113.

The optical signal processing unit 113 can control the light source 111 to change a lighting cycle, a lighting intensity, and the like of the visible light VL sent out from the light source 111. The optical signal processing unit 113 converts desired information to be transmitted to the optical wireless communication device 120-1 into an optical signal represented by a change in the visible light VL. As a result, the optical signal (downlink signal) using the visible light VL is transmitted from the optical wireless communication device 110-1 to the optical wireless communication device 120-1.

The visible light VL sent out from the light source 111 is sent out through the polarizing filter 115. A configuration of the polarizing filter 115 will be described later.

Note that the optical signal processing unit 113 may be connected to a higher-level communication network such as the Internet or an intranet.

As illustrated in FIG. 1, the optical wireless communication device 120-1 includes a visible light receiving unit 121, an infrared light transmission unit 122, and two polarizing filters 125. The visible light receiving unit 121 receives the visible light VL sent out from the light source 111. The visible light receiving unit 121 receives the visible light VL through the polarizing filter 125. Note that a configuration of the polarizing filter 125 will be described later.

The visible light receiving unit 121 reads the optical signal (downlink signal) included in the visible light VL. The optical wireless communication device 120-1 performs various types of processing such as reception processing and data conversion on the optical signal read by the visible light receiving unit 121. For example, the visible light receiving unit 121 converts the downlink signal from an optical signal into an electrical signal.

In addition, infrared light is used for an optical signal (uplink signal) transmitted from the optical wireless communication device 120-1 to the optical wireless communication device 110-1. Desired information to be transmitted to the optical wireless communication device 110-1 is converted into an optical signal represented by on and off of the infrared light, for example. The infrared light transmission unit 122 blinks and sends out the infrared light, thereby sending out the infrared light including the optical signal toward the optical wireless communication device 110-1. As a result, the optical signal (uplink signal) using the infrared light is transmitted from the optical wireless communication device 120-1 to the optical wireless communication device 110-1.

The infrared light transmission unit 122 sends out the infrared light through the polarizing filter 125. Note that a configuration of the polarizing filter 125 will be described later.

The infrared light sent out from the infrared light transmission unit 122 through the polarizing filter 125 is received by the infrared light receiving unit 112 of the optical wireless communication device 110-1. The infrared light receiving unit 112 receives the infrared light through the polarizing filter 115. A configuration of the polarizing filter 115 will be described later.

The infrared light receiving unit 112 reads the optical signal (uplink signal) included in the infrared light. The infrared light receiving unit 112 is connected to the optical signal processing unit 113. The optical signal processing unit 113 performs various types of processing such as reception processing and data conversion on the optical signal read by the infrared light receiving unit 112. Note that the optical signal processing unit 113 may transfer the optical signal subjected to the various types of processing to a higher-level communication network. In this way, optical wireless communication using visible light and infrared light is implemented.

Note that the configuration of the optical wireless communication device 110-2 is similar to the configuration of the optical wireless communication device 110-1 described above, and the configuration of the optical wireless communication device 120-2 is similar to the configuration of the optical wireless communication device 120-1 described above, and thus descriptions thereof will be omitted.

### Configuration of Polarizing Filter

Hereinafter, configurations of the polarizing filter 115 and the polarizing filter 125 will be described. Note that, since a function of the polarizing filter 125 is basically equivalent to a function of the polarizing filter 115, the polarizing filter 115 will be described herein as an example.

The polarizing filter 115 is, for example, a film in a state in which a colorless transparent film made of polyvinyl alcohol or a derivative thereof and having a thickness of about 0.1 [mm] is stretched three times to five times by using thermoelasticity or swelling elasticity and fixed, whereby polymer micelles are arranged in a fixed direction.

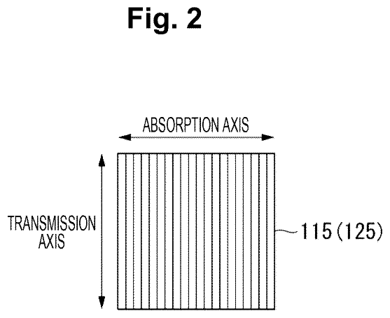

FIG. 2 is a schematic diagram illustrating the configuration of the polarizing filter 115 in the first embodiment of the present invention. Note that, as described above, the configuration of the polarizing filter 125 is similar to the configuration of the polarizing filter 115. The polarizing filter 115 is a filter that transmits only light of a specific transmission axis, and is, for example, a linear polarizing filter. Note that the polarizing filter 115 may be a filter other than the linear polarizing filter, such as a circular polarizing filter.

As illustrated in FIG. 2, the polarizing filter 115 is a linear polarizing filter having a transmission axis that is an axis in a fiber direction and an absorption axis that is an axis in a direction orthogonal to the transmission axis. For example, in a case where light randomly vibrating in 360 degrees passes through the polarizing filter 115, a wave along the transmission axis is transmitted and a wave along the absorption axis is absorbed and not transmitted due to an extremely fine slit-like structure of the polarizing filter 115. In addition, among waves vibrating obliquely, a component corresponding to the transmission axis is transmitted, and a component corresponding to the absorption axis is absorbed.

The polarizing filter 115 and the polarizing filter 125 are installed in predetermined directions, respectively, whereby light transmitted between the optical wireless communication device 110 and the optical wireless communication device 120 can be shielded or transmitted in a polarizing filter on the reception side.

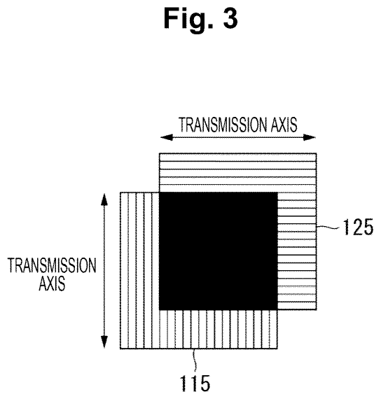

FIG. 3 is a diagram for explaining light shielding by the polarizing filter 115 and the polarizing filter 125 in the first embodiment of the present invention. In a case where the polarizing filter 115 and the polarizing filter 125 are linear polarizing filters, the polarizing filter 115 and the polarizing filter 125 are installed in directions in which their transmission axes are orthogonal to each other, whereby light is shielded. In FIG. 3, the polarizing filter 115 is installed such that the transmission axis is in the vertical direction, and the polarizing filter 125 is installed such that the transmission axis is in the horizontal direction, and the transmission axes are orthogonal to each other. Thus, in FIG. 3, a range where the polarizing filter 115 and the polarizing filter 125 overlap each other is a range where light is shielded.

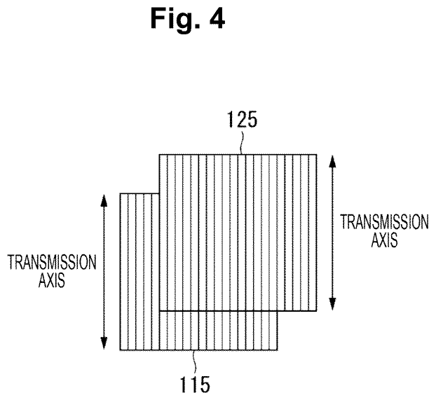

FIG. 4 is a diagram for explaining transmission of light by the polarizing filter 115 and the polarizing filter 125 in the first embodiment of the present invention. In a case where the polarizing filter 115 and the polarizing filter 125 are linear polarizing filters, the polarizing filter 115 and the polarizing filter 125 are installed in directions in which their transmission axes are parallel to each other, whereby light is transmitted. In FIG. 4, the polarizing filter 115 is installed such that the transmission axis is in the vertical direction, and the polarizing filter 125 is similarly installed such that the transmission axis is in the vertical direction, and the transmission axes are parallel to each other. Thus, in FIG. 4, light is transmitted in an entire range including the range where the polarizing filter 115 and the polarizing filter 125 overlap each other.

The optical wireless communication system 1 of the first embodiment illustrated in FIG. 1 can perform optical wireless communication without causing interference between optical signals transmitted from the respective light sources 111 by using properties of the polarizing filter 115 and the polarizing filter 125 as described above even in a case where the optical signals are simultaneously transmitted by bringing the plurality of light sources 111 of the same type close to each other.

As illustrated in FIG. 1, each of the optical wireless communication device 110-1 and the optical wireless communication device 110-2 includes the polarizing filters 115 having a transmission axis in a specific direction respectively outside the light source 111 and outside the infrared light receiving unit 112. In addition, each of the optical wireless communication device 120-1 and the optical wireless communication device 120-2 includes polarizing filters 125 having a transmission axis in a specific direction respectively outside the visible light receiving unit 121 and outside the infrared light transmission unit 122.

As illustrated in FIG. 1, in a case of a combination of the optical wireless communication device 110 and the optical wireless communication device 120 in which the transmission axis of the polarizing filter 115 and the transmission axis of the polarizing filter 125 match each other, optical wireless communication is possible. This is because a direction of the transmission axis of the polarizing filter 115 and a direction of the transmission axis of the polarizing filter 125 are the same, so that light transmitted through the polarizing filter 115 is also transmitted through the polarizing filter 125. Similarly, this is because light transmitted through the polarizing filter 125 is also transmitted through the polarizing filter 115.

In FIG. 1, the direction of the transmission axis of the polarizing filter 115 of the optical wireless communication device 110-1 matches the direction of the transmission axis of the polarizing filter 125 of the optical wireless communication device 120-1 (in FIG. 1, both the directions of the transmission axes are in the vertical direction). For that reason, the optical wireless communication device 110-1 and the optical wireless communication device 120-1 can perform optical wireless communication. In addition, in FIG. 1, the direction of the transmission axis of the polarizing filter 115 of the optical wireless communication device 110-2 matches the direction of the transmission axis of the polarizing filter 125 of the optical wireless communication device 120-2 (in FIG. 1, both the directions of the transmission axes are in the horizontal direction). For that reason, the optical wireless communication device 110-2 and the optical wireless communication device 120-2 can perform optical wireless communication.

On the other hand, in FIG. 1, the direction of the transmission axis of the polarizing filter 115 of the optical wireless communication device 110-1 is the vertical direction, the direction of the transmission axis of the polarizing filter 125 of the optical wireless communication device 120-2 is the horizontal direction, and the directions of both transmission axes are orthogonal to each other. For that reason, the optical wireless communication device 110-1 and the optical wireless communication device 120-2 cannot perform optical wireless communication. In addition, in FIG. 1, the direction of the transmission axis of the polarizing filter 115 of the optical wireless communication device 110-2 is the horizontal direction, the direction of the transmission axis of the polarizing filter 125 of the optical wireless communication device 120-1 is the vertical direction, and the directions of both transmission axes are orthogonal to each other. For that reason, the optical wireless communication device 110-2 and the optical wireless communication device 120-1 cannot perform optical wireless communication.

This is because the direction of the transmission axis of the polarizing filter 115 and the direction of the transmission axis of the polarizing filter 125 are orthogonal to each other, so that light transmitted through the polarizing filter 115 does not transmit through the polarizing filter 125. Similarly, this is because light transmitted through the polarizing filter 125 does not transmit through the polarizing filter 115.

With such a configuration, according to the optical wireless communication system 1 in the first embodiment, pieces of the visible light VL sent out from the respective plurality of light sources 111 close to each other and transmitted through the polarizing filter 115 or the polarizing filter 125 do not interfere with each other on the reception side. As a result, the optical wireless communication system 1 can prevent deterioration of transmission quality due to interference.

Specifically, as illustrated in FIG. 1, the polarizing filters (the polarizing filter 115 and the polarizing filter 125) of the optical wireless communication devices that perform optical wireless communication with each other are installed such that the transmission axes thereof are in the same direction, and the polarizing filters of the optical wireless communication devices that do not perform optical wireless communication with each other are installed such that the transmission axes thereof are in different directions (for example, orthogonal directions), whereby it is possible to prevent interference between optical signals in a plurality of optical wireless communications.

Note that, as described above, the polarizing filter 115 and the polarizing filter 125 do not necessarily for linear polarization, and may be for circular polarization or the like, for example. The present invention is not limited to the configuration of the optical wireless communication system 1 described above as long as the optical wireless communication system can simultaneously perform spatial multiplex transmission by a combination of polarizing filters having different (for example, orthogonal) transmission axes.

Note that a configuration may be adopted in which the polarizing filter 115 is provided only in the light source 111 of the optical wireless communication device 110, and the polarizing filter 125 is provided only in the visible light receiving unit 121 of the optical wireless communication device 120. That is, a configuration may be adopted in which the polarizing filter 115 and the polarizing filter 125 are used only for the downlink signal, and only interference between optical signals in transmission of the downlink signal is prevented. In addition, conversely, a configuration may be adopted in which the polarizing filter 115 is provided only in the infrared light receiving unit 112 of the optical wireless communication device 110, and the polarizing filter 125 is provided only in the infrared light transmission unit 122 of the optical wireless communication device 120. That is, a configuration may be adopted in which the polarizing filter 115 and the polarizing filter 125 are used only for the uplink signal, and only interference between optical signals in transmission of the uplink signal is prevented.

Note that the optical wireless communication system 1 illustrated in FIG. 1 has a configuration in which the optical wireless communication device 110 includes one light source 111 and one infrared light receiving unit 112, but may include a plurality of the light sources 111 and a plurality of the infrared light receiving units 112. For example, a configuration may be adopted in which one optical wireless communication device 110 performs optical wireless communication with both the optical wireless communication device 120-1 and the optical wireless communication device 120-2 by respectively using the polarizing filters 115 installed in directions different from each other.

Note that types and directions of the transmission axes of the polarizing filters 115 provided in the light source 111 and the infrared light receiving unit 112 may be the same or different. Similarly, types and directions of the transmission axes of the polarizing filters 125 provided in the visible light receiving unit 121 and the infrared light transmission unit 122 may be the same or different. That is, as long as a configuration is made in which the same light is transmitted between the optical wireless communication devices (for example, the optical wireless communication device 110-1 and the optical wireless communication device 120-1, and the optical wireless communication device 110-2 and the optical wireless communication device 120-2) that perform optical wireless communication with each other, and the same light is not transmitted between the optical wireless communication devices (for example, the optical wireless communication device 110-1 and the optical wireless communication device 120-2, and the optical wireless communication device 110-2 and the optical wireless communication device 120-1) that do not perform optical wireless communication with each other, the types and the directions of the transmission axes of the polarizing filter 115 and the polarizing filter 125 can be arbitrarily selected.

### Correction Processing for Direction of Transmission Axis of Polarizing Filter

Hereinafter, a description will be given of correction processing for the direction of the transmission axis of the polarizing filter 125 by the optical wireless communication device 120 of the optical wireless communication system 1 in the first embodiment.

In a case where at least one of the optical wireless communication device 110 or the optical wireless communication device 120 is a device that may make a movement accompanied by rotation or the like, for example, the direction of the transmission axis of the polarizing filter changes according to the movement. That is, in a case where there is a change in a positional relationship between the optical wireless communication device 110 and the optical wireless communication device 120 or the direction of at least one of the optical wireless communication device 110 or the optical wireless communication device 120, a shift (deviation) may occur between the direction of the transmission axis of the polarizing filter 115 of the optical wireless communication device 110 and the direction of the transmission axis of the polarizing filter 125 of the optical wireless communication device 120. In a case where a shift occurs in the direction of the transmission axis of the polarizing filter between the optical wireless communication device 110 and the optical wireless communication device 120, the optical signal is shielded by the polarizing filter of the optical wireless communication device on the reception side, so that transmission characteristics deteriorate.

The optical wireless communication device 120 of the optical wireless communication system in the first embodiment includes a rotation mechanism that rotates the polarizing filter 125 to be able to correct the shift generated between the direction of the transmission axis of the polarizing filter 115 of the optical wireless communication device 110 and the direction of the transmission axis of the polarizing filter 125 of the optical wireless communication device 120. Note that, in the present embodiment, as an example, a case will be described where the rotation mechanism is provided only in the optical wireless communication device 120, but the present invention is not limited to this configuration. The rotation mechanism may be provided in both the optical wireless communication device 110 and the optical wireless communication device 120, or may be provided only in the optical wireless communication device 110.

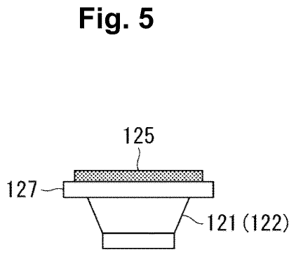

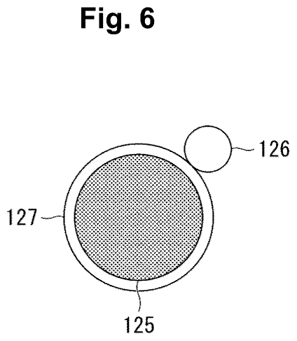

FIGS. 5 and 6 are diagrams for explaining a configuration of a rotation mechanism 127 of the polarizing filter 125 included in the optical wireless communication device 120 in the first embodiment of the present invention. FIG. 5 is a side view of a periphery of the rotation mechanism 127 of the optical wireless communication device 120, and FIG. 6 is a plan view of the periphery of the rotation mechanism 127 of the optical wireless communication device 120.

As illustrated in FIG. 5, the rotation mechanism 127 is provided between each of the visible light receiving unit 121 and the infrared light transmission unit 122, and the polarizing filter 125. Note that, in a case where infrared light is used to transmit the downlink signal, the rotation mechanism 127 is provided between an infrared light receiving unit (not illustrated) and the polarizing filter 125. The polarizing filter 125 is fixedly installed to the rotation mechanism 127. The rotation mechanism 127 is installed movably (that is, the rotation mechanism 127 can make rotational movement) with respect to the visible light receiving unit 121 and the infrared light transmission unit 122.

In addition, as illustrated in FIG. 6, a polarizing filter rotation mechanism driving unit 126 is provided to be in contact with the rotation mechanism 127. The polarizing filter rotation mechanism driving unit 126 rotates the rotation mechanism 127 under control of a polarizing filter control unit 124 described later. For example, a configuration may be adopted in which the polarizing filter rotation mechanism driving unit 126 is rotated by power from a power source (not illustrated) such as a motor, and the rotation mechanism 127 in contact with the polarizing filter rotation mechanism driving unit 126 rotates in an opposite direction in conjunction with the polarizing filter rotation mechanism driving unit 126. As a result, an installation direction of the polarizing filter 125 fixedly installed to the rotation mechanism 127 also changes, and the direction of the transmission axis of the polarizing filter 125 changes.

### Configuration of Optical Wireless Communication Device

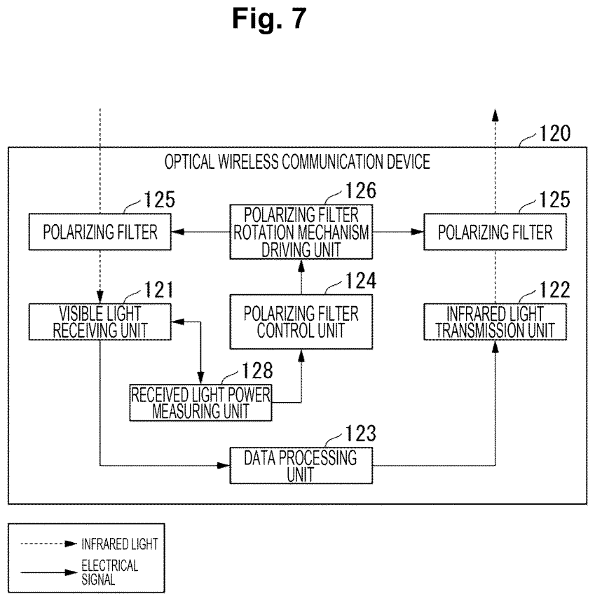

Hereinafter, a detailed description will be given of a configuration of the optical wireless communication device 120. FIG. 7 is a block diagram illustrating the configuration of the optical wireless communication device 120 in the first embodiment of the present invention. The optical wireless communication device 120 is a small terminal device in which the direction of the optical wireless communication device 120 may change due to rotation or the like, for example. The optical wireless communication device 120 functions as a wireless communication terminal accommodated in the facing optical wireless communication device 110.

As illustrated in FIG. 7, the optical wireless communication device 120 includes the visible light receiving unit 121, the infrared light transmission unit 122, a data processing unit 123, the polarizing filter control unit 124, two polarizing filters 125, the polarizing filter rotation mechanism driving unit 126, and a received light power measuring unit 128.

Note that, as an example, the optical wireless communication device 120 illustrated in FIG. 7 is assumed to be a terminal device included in an optical wireless communication system that transmits a downlink signal by using visible light VL and transmits an uplink signal by using infrared light. However, the present invention is not limited to such a configuration, and for example, a configuration may be adopted in which infrared light is used for both transmission of the downlink signal and transmission of the uplink signal.

The visible light receiving unit 121 receives the visible light VL sent out from the facing optical wireless communication device 110. The visible light receiving unit 121 receives the visible light VL through the polarizing filter 125. Note that the configuration of the polarizing filter 125 is as described above with reference to FIGS. 2 to 4.

The visible light receiving unit 121 reads the optical signal (downlink signal) included in the visible light VL. The visible light receiving unit 121 performs various types of processing such as reception processing and data conversion on the read optical signal. For example, the visible light receiving unit 121 converts the downlink signal from an optical signal into an electrical signal. The visible light receiving unit 121 is connected to the data processing unit 123. The visible light receiving unit 121 outputs the signal subjected to the various types of processing to the data processing unit 123.

In addition, infrared light is used for an optical signal (uplink signal) transmitted from the optical wireless communication device 120 to the optical wireless communication device 110. An electrical signal indicating desired information transmitted to the optical wireless communication device 110 is converted into an optical signal represented by, for example, on and off of the infrared light by the infrared light transmission unit 122. The infrared light transmission unit 122 blinks and sends out the infrared light, thereby sending out the infrared light including the optical signal toward the optical wireless communication device 110. As a result, the optical signal (uplink signal) using the infrared light is transmitted from the optical wireless communication device 120 to the optical wireless communication device 110.

The infrared light transmission unit 122 sends out the infrared light through the polarizing filter 125. Note that the configuration of the polarizing filter 125 is similar to the configuration of the polarizing filter 125 described above with reference to FIGS. 2 to 4.

The received light power measuring unit 128 measures a signal intensity of the visible light VL received by the visible light receiving unit 121. The received light power measuring unit 128 outputs information indicating a result of measurement of the signal intensity to the polarizing filter control unit 124.

The polarizing filter control unit 124 acquires the information indicating the result of measurement of the signal intensity output from the received light power measuring unit 128. On the basis of the information indicating the result of measurement of the signal intensity, the polarizing filter control unit 124 instructs the polarizing filter rotation mechanism driving unit 126 to rotate the polarizing filter 125 in a direction in which the signal intensity of the visible light VL received by the visible light receiving unit 121 is higher.

Specifically, for example, the polarizing filter control unit 124 rotates the polarizing filter 125 in a specific direction (for example, clockwise) by a predetermined angle, and compares a signal intensity before rotation with a signal intensity after rotation. As a result of comparison, in a case where the signal intensity after rotation is higher than the signal intensity before rotation, or in a case where the signal intensity before rotation is the same as the signal intensity after rotation, the polarizing filter control unit 124 rotates the polarizing filter 125 again in the same direction (for example, clockwise) by a predetermined angle. In addition, as a result of comparison, in a case where the signal intensity before rotation is higher than the signal intensity after rotation, the polarizing filter control unit 124 rotates the polarizing filter 125 in an opposite direction (for example, counterclockwise) by a predetermined angle.

By repeating processing as described above, the polarizing filter control unit 124 controls the direction of the transmission axis of the polarizing filter 125 to cause the signal intensity of the visible light VL received by the visible light receiving unit 121 to be higher (or, the highest). Control as described above is performed, whereby the shift (deviation) is corrected between the direction of the transmission axis of the polarizing filter 115 of the optical wireless communication device 110 and the direction of the transmission axis of the polarizing filter 125 of the optical wireless communication device 120.

### Operation of Optical Wireless Communication Device

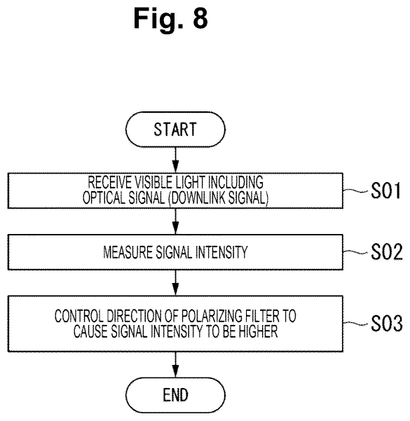

Hereinafter, a description will be given of an example of operation of the optical wireless communication device 120. FIG. 8 is a flowchart illustrating operation of the optical wireless communication device 120 in the first embodiment of the present invention. The operation of the optical wireless communication device 120 illustrated in the flowchart of FIG. 8 is started when the visible light VL including the optical signal (downlink signal) is sent out from the optical wireless communication device 110 to the optical wireless communication device 120.

The visible light receiving unit 121 receives the visible light VL including the optical signal (downlink signal) sent out from the facing optical wireless communication device 110 (step S01). The received light power measuring unit 128 measures a signal intensity of the visible light VL received by the visible light receiving unit 121 (step S02). The received light power measuring unit 128 outputs information indicating a result of measurement of the signal intensity to the polarizing filter control unit 124.

The polarizing filter control unit 124 acquires the information indicating the result of measurement of the signal intensity output from the received light power measuring unit 128. On the basis of the information indicating the result of measurement of the signal intensity, the polarizing filter control unit 124 controls the direction of the transmission axis of the polarizing filter 125 to cause the signal intensity of the visible light VL received by the visible light receiving unit 121 to be higher (step S03). Thus, the operation of the optical wireless communication device 120 illustrated in the flowchart in FIG. 8 ends.

With the configuration as described above, the optical wireless communication system 1 in the first embodiment can perform optical wireless communication without causing interference between optical signals even in a case where the optical signals are respectively transmitted by using a plurality of light sources of the same type installed close to each other.

Further, in the optical wireless communication system 1 in the first embodiment, the optical wireless communication device 120 includes the rotation mechanism 127 that changes the direction of the transmission axis of the polarizing filter 125. The polarizing filter control unit 124 has a configuration for controlling the direction of the transmission axis of polarizing filter 125 to cause the signal intensity of the visible light VL received by the visible light receiving unit 121 to be higher. With such a configuration, as a result, the optical wireless communication system 1 can correct the shift between the direction of the transmission axis of the polarizing filter 115 of the optical wireless communication device 110 and the direction of the transmission axis of the polarizing filter 125 of the optical wireless communication device 120. As a result, the optical wireless communication system 1 in the first embodiment can perform optical wireless communication without causing interference between optical signals even in a case where the optical wireless communication device 120 may make movement accompanied by rotation or the like.

Note that, in the present embodiment, the optical wireless communication device 120 includes the rotation mechanism that rotates the polarizing filter 125 in accordance with rotation of the optical wireless communication device 120 to cope with a change in the direction of the transmission axis of the polarizing filter 125 accompanying the rotation of the optical wireless communication device 120. However, the present invention is not limited to such a configuration, and for example, a configuration may be adopted in which the optical wireless communication device 120 includes a rotation mechanism that rotates not only the polarizing filter 125 but also a part or all of the optical wireless communication device 120 in accordance with the rotation of the optical wireless communication device 120.

Note that the polarizing filter control unit 124 may give an instruction to rotate the polarizing filter 115 of the optical wireless communication device 110 in a direction in which the signal intensity of the visible light VL received by the visible light receiving unit 121 is higher on the basis of the information indicating the result of measurement of the signal intensity. In this case, the polarizing filter control unit 124 may transmit instruction information to the optical wireless communication device 110 by using the optical signal (uplink signal), or may transmit the instruction information by using a signal in another communication scheme. In this case, the instruction information may include, for example, information indicating the result of measurement of the signal intensity, information for designating the direction of the transmission axis of the polarizing filter 115, or the like. In addition, in this case, the optical wireless communication device 110 includes a rotation mechanism for changing the direction of the transmission axis of the polarizing filter 115.

Note that a configuration may be adopted in which the optical wireless communication system 1 includes a control station (not illustrated) that collectively performs rotation control of the polarizing filters 125 of a plurality of the optical wireless communication devices 120. In addition, a configuration may be adopted in which the plurality of optical wireless communication devices 120 can mutually recognize the direction of the transmission axis of an appropriate polarizing filter by exchanging information regarding such control between the plurality of optical wireless communication devices 120.

### Second Embodiment

Hereinafter, a second embodiment of the present invention will be described. The optical wireless communication system 1 in the first embodiment described above has a configuration capable of correcting the shift (deviation) between the direction of the transmission axis of the polarizing filter 115 of the optical wireless communication device 110 and the direction of the transmission axis of the polarizing filter 125 of the optical wireless communication device 120, which is caused by a change in the positional relationship between the optical wireless communication device 110 and the optical wireless communication device 120 or the direction of at least one of the optical wireless communication device 110 or the optical wireless communication device 120.

In addition to a case where the rotation control of the polarizing filter is performed to correct such an originally unintended shift, there is a case where it is desired to intentionally perform the rotation control of the polarizing filter. For example, there is a case where it is desired to dynamically change a combination of the optical wireless communication device 110 and the optical wireless communication device 120 that are caused to communicate with each other according to a communication traffic occurrence situation or the like. In such a case, the direction of the transmission axis of the polarizing filter is dynamically changed, whereby change processing described above can be implemented.

Note that, since an overall configuration of an optical communication system in the second embodiment is basically similar to the overall configuration of the optical wireless communication system 1 in the first embodiment illustrated in FIG. 1 described above, the description thereof will be omitted.

### Configuration of Optical Wireless Communication Device

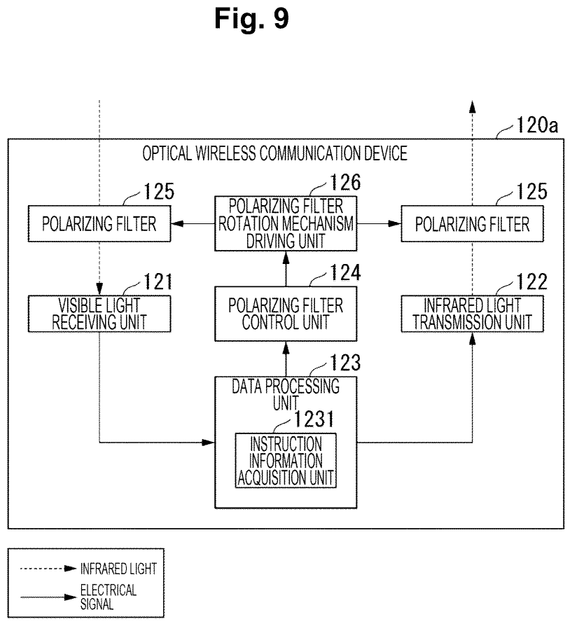

Hereinafter, a description will be given of a configuration of the optical wireless communication device 120a of the optical wireless communication system in the second embodiment. FIG. 9 is a block diagram illustrating the configuration of the optical wireless communication device 120a in the second embodiment of the present invention. The optical wireless communication device 120a is, for example, a small terminal device. The optical wireless communication device 120a functions as a wireless communication terminal accommodated in the facing optical wireless communication device 110 (not illustrated).

As illustrated in FIG. 9, the optical wireless communication device 120a includes the visible light receiving unit 121, the infrared light transmission unit 122, the data processing unit 123, the polarizing filter control unit 124, two polarizing filters 125, and the polarizing filter rotation mechanism driving unit 126.

Note that the optical wireless communication device 120a illustrated in FIG. 9 is assumed to be a terminal device included in an optical wireless communication system that transmits the downlink signal by using visible light VL and transmits the uplink signal by using infrared light, similarly to the optical wireless communication system 1 in the first embodiment described above. However, the present invention is not limited to such a configuration, and for example, a configuration may be adopted in which infrared light is used for both transmission of the downlink signal and transmission of the uplink signal.

The visible light receiving unit 121 receives the visible light VL sent out from the facing optical wireless communication device 110 (not illustrated). The visible light receiving unit 121 receives the visible light VL through the polarizing filter 125. Note that the configuration of the polarizing filter 125 is similar to the configuration of the polarizing filter 115 illustrated in FIGS. 2 to 4 described above, and thus description thereof will be omitted.

The visible light receiving unit 121 reads the optical signal (downlink signal) included in the visible light VL. The visible light receiving unit 121 performs various types of processing such as reception processing and data conversion on the read optical signal. For example, the visible light receiving unit 121 converts the downlink signal from an optical signal into an electrical signal. The visible light receiving unit 121 is connected to the data processing unit 123. The visible light receiving unit 121 outputs the signal subjected to the various types of processing to the data processing unit 123.

In addition, infrared light is used for an optical signal (uplink signal) transmitted from the optical wireless communication device 120a to the optical wireless communication device 110 (not illustrated). Desired information to be transmitted to the optical wireless communication device 110 (not illustrated) is converted into an optical signal represented by on and off of the infrared light, for example. The infrared light transmission unit 122 blinks and sends out the infrared light, thereby sending out the infrared light including the optical signal toward the optical wireless communication device 110 (not illustrated). As a result, the optical signal (uplink signal) using the infrared light is transmitted from the optical wireless communication device 120a to the optical wireless communication device 110 (not illustrated).

The infrared light transmission unit 122 sends out the infrared light through the polarizing filter 125. Note that the configuration of the polarizing filter 125 is similar to the configuration of the polarizing filter 115 illustrated in FIGS. 2 to 4 described above, and thus description thereof will be omitted.

As illustrated in FIG. 9, the data processing unit 123 includes an instruction information acquisition unit 1231. The instruction information acquisition unit 1231 reads instruction information from the signal acquired from the visible light receiving unit 121. The instruction information acquisition unit 1231 outputs the read instruction information to the polarizing filter control unit 124. The instruction information referred to here is information that designates the direction of the transmission axis of the polarizing filter 125 provided in the optical wireless communication device 120a. The optical wireless communication device 110 sends out the visible light VL including the optical signal (downlink signal) indicating the instruction information to the optical wireless communication device 120a.

Note that information indicating the direction of the transmission axis of the polarizing filter 125 designated for the optical wireless communication device 120a (that is, information that is a source of the instruction information) is transmitted from, for example, a higher-level network to the optical wireless communication device 110. For example, to dynamically change a combination of the optical wireless communication device 110 and the optical wireless communication device 120a that are caused to communicate with each other according to a traffic occurrence situation or the like, the higher-level network determines the directions of the transmission axes of the polarizing filters 125 to be designated for the respective optical wireless communication devices 120a.

Note that it does not necessarily have to adopt a configuration in which the instruction information is transmitted from the optical wireless communication device 110 to the optical wireless communication device 120a by an optical signal using the visible light VL. For example, a configuration may be adopted in which instruction information is transmitted from the optical wireless communication device 110, a higher-level network, or the like to the optical wireless communication device 120a, by communication using, for example, a cellular system such as 5th Generation Mobile Communication System (5G), a wireless local area network (LAN), a wired LAN, or any other communication scheme.

The polarizing filter control unit 124 rotates each of the two polarizing filters 125 such that the directions of the transmission axes of the two polarizing filters 125 are the directions designated by the instruction information acquired from the instruction information acquisition unit 1231. As a result, it is possible to dynamically change the combination of the optical wireless communication device 110 and the optical wireless communication device 120a that communicate with each other.

Note that the configuration of the facing optical wireless communication device 110 (not illustrated) is basically similar to the configuration of the optical wireless communication device 110 of the optical wireless communication system 1 in the first embodiment described above, and thus the description thereof will be omitted.

### Operation of Optical Wireless Communication Device

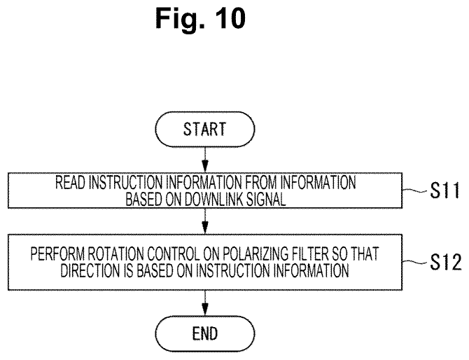

Hereinafter, a description will be given of an example of operation of the optical wireless communication device 120a. FIG. 10 is a flowchart illustrating operation of the optical wireless communication device 120a in the second embodiment of the present invention. The operation of the optical wireless communication device 120a illustrated in the flowchart of FIG. 10 is started when the visible light receiving unit 121 reads the optical signal (downlink signal) including the instruction information and included in the visible light VL sent out from the facing optical wireless communication device 110 (not illustrated) and outputs a signal subjected to various types of processing to the data processing unit 123.

The instruction information acquisition unit 1231 of the data processing unit 123 reads the instruction information from the signal acquired from the visible light receiving unit 121 (step S11). Note that, as described above, the instruction information referred to here is information that designates the direction of the transmission axis of the polarizing filter 125 provided in the optical wireless communication device 120a. The instruction information acquisition unit 1231 outputs the read instruction information to the polarizing filter control unit 124.

Next, the polarizing filter control unit 124 performs rotation control on each of the two polarizing filters 125 so that the directions of the transmission axes of the two polarizing filters 125 are the directions designated by the instruction information acquired from the instruction information acquisition unit 1231 (step S12). Thus, the operation of the optical wireless communication device 120a illustrated in the flowchart in FIG. 10 ends.

With the configuration as described above, the optical wireless communication system in the second embodiment can perform optical wireless communication without causing interference between optical signals even in a case where the optical signals are respectively transmitted by using a plurality of light sources of the same type, similarly to the optical wireless communication system 1 in the first embodiment described above.

Note that a configuration may be adopted in which the instruction information indicating the designated direction of the transmission axis of the polarizing filter 125 transmitted to the optical wireless communication device 120a is shared among the plurality of optical wireless communication devices 110. In this case, it is possible to perform control so that the directions of the transmission axes of the polarizing filters 125 do not match each other between a plurality of the optical wireless communication devices 120a close to each other, and thus, it is possible to perform optical wireless communication without causing interference between optical signals. As described above, the directions of the transmission axes of the polarizing filters can be adjusted to be different from each other between communication links formed close to each other.

Note that a configuration may be adopted in which the configuration of the optical wireless communication system 1 in the first embodiment described above is combined with the configuration of the optical wireless communication system in the second embodiment. That is, the optical wireless communication system may simultaneously perform control to change the direction of the transmission axis of the polarizing filter to cause the signal intensity of the optical signal transmitted by the optical wireless communication to be higher while dynamically changing the combination of the optical wireless communication device 110 and the optical wireless communication device 120 (120a) that are caused to communicate with each other by transmission of the instruction information.

Note that, in the first embodiment and the second embodiment described above, a case has been described where the direction of the transmission axis of the polarizing filter 115 or the polarizing filter 125 for transmission is the same as the direction of the transmission axis of the polarizing filter 115 or the polarizing filter 125 for reception, in the optical wireless communication device 110 and the optical wireless communication device 120; however, the present invention is not limited to this configuration, and the directions may be different from each other.

Note that, in the first embodiment and the second embodiment described above, the optical wireless communication system using visible light and infrared light has been described, but the present invention is not limited to this configuration. The present invention can be applied to a case of performing any optical wireless communication including, for example, a laser and the like belonging to so-called free-space optical communication (FSO) as long as the optical wireless communication system uses a polarizing filter.

According to the optical wireless communication system 1 in the first embodiment and the optical wireless communication system in the second embodiment described above, even in a case where optical wireless transmissions are respectively performed by using light sources of the same type installed close to each other, optical wireless communications can be performed without causing interference between respective communication links. As a result, an increase in communication capacity and throughput can be expected.

In addition, in the optical wireless communication system 1 in the first embodiment and the optical wireless communication system in the second embodiment described above, two optical wireless communication devices facing each other respectively include polarizing filters installed to have the same transmission axis direction or polarizing filters controlled to have the same transmission axis direction. As a result, the optical wireless communication can be established only between communication links formed through polarizing filters having the same transmission axis direction, so that occurrence of the interference between the communication links can be prevented.

According to the above-described embodiment, the optical wireless communication system includes a plurality of first optical wireless communication devices and a plurality of second optical wireless communication devices. For example, the optical communication system is the optical wireless communication system 1 in the embodiment, the first optical wireless communication device is the optical wireless communication device 110 in the embodiment, and the second optical wireless communication device is the optical wireless communication device 120a in the embodiment. The optical wireless communications system forms a communication link for each combination of the first optical wireless communication device and the second optical wireless communication device.

The first optical wireless communication device includes a transmission unit. For example, the transmission unit is the light source 111 in the embodiment. The transmission unit transmits an optical signal to the second optical wireless communication device via the first polarizing filter. For example, the first polarizing filter is the polarizing filter 115 in the embodiment, and the optical signal is the optical signal (downlink signal) transmitted by using the visible light VL in the embodiment. The second optical wireless communication device includes a reception unit, a measurement unit, and a control unit. For example, the reception unit is the visible light receiving unit 121 in the embodiment, the measurement unit is the received light power measuring unit 128 in the embodiment, and the control unit is the polarizing filter control unit 124 in the embodiment. The reception unit receives the optical signal through the second polarizing filter. For example, the second polarizing filter is the polarizing filter 125 in the embodiment. The measurement unit measures the signal intensity of the optical signal. The control unit changes the direction of the second polarizing filter or the first polarizing filter to cause the signal intensity to be higher. For example, the direction of the second polarizing filter is the direction of the transmission axis of the polarizing filter 125 in the embodiment.

In addition, according to the above-described embodiment, the optical wireless communication system includes a plurality of first optical wireless communication devices and a plurality of second optical wireless communication devices. For example, the first optical wireless communication device is the optical wireless communication device 110 in the embodiment, and the second optical wireless communication device is the optical wireless communication device 120a in the embodiment. The optical wireless communications system forms a communication link for each combination of the first optical wireless communication device and the second optical wireless communication device.

The first optical wireless communication device includes a transmission unit. For example, the transmission unit is the light source 111 in the embodiment. The transmission unit transmits, to the second optical wireless communication device via the first polarizing filter, an optical signal including instruction information designating a direction of the second polarizing filter. For example, the first polarizing filter is the polarizing filter 115 in the embodiment, the second polarizing filter is the polarizing filter 125 in the embodiment, and the optical signal is the optical signal (downlink signal) transmitted by using the visible light VL in the embodiment. The second optical wireless communication device includes a reception unit, an acquisition unit, and a control unit. For example, the reception unit is the visible light receiving unit 121 in the embodiment, the acquisition unit is the instruction information acquisition unit 1231 in the embodiment, and the control unit is the polarizing filter control unit 124 in the embodiment. The reception unit receives the optical signal through the second polarizing filter. The acquisition unit acquires the instruction information from the optical signal. The control unit changes the direction of the second polarizing filter to cause the direction of the second polarizing filter to be a direction designated by the instruction information. For example, the direction of the second polarizing filter is the direction of the transmission axis of the polarizing filter 125 in the embodiment, and the direction of the first polarizing filter is the direction of the transmission axis of the polarizing filter 115 in the embodiment.

Note that, in the optical wireless communication system, the second optical wireless communication device may further include a rotation mechanism. For example, the rotation mechanism is the rotation mechanism 127 in the embodiment. In this case, the rotation mechanism makes the second polarizing filter rotatable. The control unit changes the direction of the second polarizing filter by using the rotation mechanism.

Note that, in the optical wireless communication system, the direction of the first polarizing filter included in one first optical wireless communication device and the direction of the first polarizing filter included in the other first optical wireless communication device may be directions orthogonal to each other. For example, one first optical wireless communication device is the optical wireless communication device 110-1 in the embodiment, and the other first optical wireless communication device is the optical wireless communication device 110-2 in the embodiment.

In addition, according to the above-described embodiment, the optical wireless communication device includes a reception unit, a measurement unit, and a control unit. For example, the reception unit is the visible light receiving unit 121 in the embodiment, the measurement unit is the received light power measuring unit 128 in the embodiment, and the control unit is the polarizing filter control unit 124 in the embodiment. The reception unit receives, via the second polarizing filter, an optical signal transmitted from another optical wireless communication device via the first polarizing filter. For example, the second polarizing filter is the polarizing filter 125 in the embodiment. The measurement unit measures the signal intensity of the optical signal. The control unit changes the direction of the second polarizing filter or the first polarizing filter to cause the signal intensity to be higher. For example, the direction of the second polarizing filter is the direction of the transmission axis of the polarizing filter 125 in the embodiment, and the direction of the first polarizing filter is the direction of the transmission axis of the polarizing filter 115 in the embodiment.

In addition, according to the above-described embodiment, the optical wireless communication device includes a reception unit, an acquisition unit, and a control unit. For example, the reception unit is the visible light receiving unit 121 in the embodiment, the acquisition unit is the instruction information acquisition unit 1231 in the embodiment, and the control unit is the polarizing filter control unit 124 in the embodiment. The reception unit receives, via the second polarizing filter, an optical signal transmitted from another wireless communication device via the first polarizing filter and including instruction information designating the direction of the second polarizing filter. For example, the other wireless communication device is the optical wireless communication device 110 in the embodiment, the first polarizing filter is the polarizing filter 115 in the embodiment, the second polarizing filter is the polarizing filter 125 in the embodiment, and the optical signal is the optical signal (downlink signal) transmitted by using the visible light VL in the embodiment. The acquisition unit acquires the instruction information from the optical signal. The control unit changes the direction of the second polarizing filter to cause the direction of the second polarizing filter to be a direction designated by the instruction information. For example, the direction of the second polarizing filter is the direction of the transmission axis of the polarizing filter 125 in the embodiment.

A part of the optical wireless communication device 110, a part of the optical wireless communication device 120, and a part of the optical wireless communication device 120a in the above-described embodiments may be implemented by a computer. In that case, a program for implementing this function may be recorded in a computer-readable recording medium, and the function may be implemented by causing a computer system to read the program recorded in the recording medium, and executing the program. Note that, the “computer system” referred to herein includes an OS and hardware such as peripheral equipment. In addition, the “computer-readable recording medium” refers to a portable medium such as a flexible disk, a magneto-optical disc, a ROM, or a CD-ROM or a storage device such as a hard disk included in the computer system.

Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing a part of the function described above, may be implemented in a combination with a program already recorded in a computer system, or may be implemented with a programmable logic device such as a field programmable gate array (FPGA).

Although the embodiments of the present invention have been described in detail with reference to the drawings, the specific configuration is not limited to the embodiments, and includes design and the like within the scope not departing from the gist of the present invention.

### Reference Signs List

1, 8, 8′, 9 Optical wireless communication system
110, 110-1, 110-2 Optical wireless communication device
111 Light source
112 Infrared light receiving unit
113 Optical signal processing unit
115 Polarizing filter
120, 120-1, 120-2, 120a Optical wireless communication device
121 Visible light receiving unit
122 Infrared light transmission unit
23 Data processing unit
124 Polarizing filter control unit
125 Polarizing filter
126 Polarizing filter rotation mechanism driving unit
127 Rotation mechanism
128 Received light power measuring unit
810, 810-1, 810-2 Optical wireless communication device
811 Light source
812 Infrared light receiving unit
813 Optical signal processing unit
820, 820-1, 820-2 Optical wireless communication device
821 Visible light receiving unit
822 Infrared light transmission unit
910 Optical wireless communication device
911 Infrared light transmission unit
912 Infrared light receiving unit
913 Optical signal processing unit
920 Optical wireless communication device
921 Infrared light receiving unit
922 Infrared light transmission unit
1231 Instruction information acquisition unit

1. An optical wireless communication system comprising a plurality of first optical wireless communication devices, and a plurality of second optical wireless communication devices, the optical wireless communication system forming a communication link for each of combinations of the first optical wireless communication devices and the second optical wireless communication devices,
wherein
the first optical wireless communication devices include
a transmission unit that transmits an optical signal to the second optical wireless communication devices via a first polarizing filter,
and
the second optical wireless communication devices include:
a reception unit that receives the optical signal via a second polarizing filter;
a processor; and
a storage medium having computer program instructions stored thereon, when executed by the processor, perform to:
measure a signal intensity of the optical signal; and
change a direction of the second polarizing filter or the first polarizing filter to cause the signal intensity to be higher.

2. (canceled)

3. The optical wireless communication system according to claim 1, wherein
the second optical wireless communication devices further include
a rotation mechanism that makes the second polarizing filter rotatable,
and
the computer program instructions further perform to change the direction of the second polarizing filter by using the rotation mechanism.

4. The optical wireless communication system according to claim 1, wherein
a direction of the first polarizing filter included in one of the first optical wireless communication devices and a direction of the first polarizing filter included in another of the first optical wireless communication devices are directions orthogonal to each other.

5. (canceled)

6. An optical wireless communication device comprising:
a reception unit that receives, via a second polarizing filter, an optical signal transmitted from another wireless communication device via a first polarizing filter, the optical signal including instruction information designating a direction of the second polarizing filter;
a processor; and
a storage medium having computer program instructions stored thereon, when executed by the processor, perform to:
acquire the instruction information from the optical signal; and
change the direction of the second polarizing filter to cause the direction of the second polarizing filter to be the direction designated by the instruction information.

7. An optical wireless communication method by an optical wireless communication system including a plurality of first optical wireless communication devices, and a plurality of second optical wireless communication devices, the optical wireless communication system forming a communication link for each of combinations of the first optical wireless communication devices and the second optical wireless communication devices,
the optical wireless communication method comprising:
a transmission step in which the first optical wireless communication devices transmit an optical signal to the second optical wireless communication devices via a first polarizing filter;
a reception step in which the second optical wireless communication devices receive the optical signal via a second polarizing filter;
a measurement step in which the second optical wireless communication devices measure a signal intensity of the optical signal; and
a control step in which the second optical wireless communication devices change a direction of the second polarizing filter or the first polarizing filter to cause the signal intensity to be higher.

8. (canceled)
